(19) United States
(12) Patent Application Publication
(10) Pub. No.: US 2016/0238124 A1
(43) Pub. Date: Aug. 18, 2016

(54) TRANSMISSION CASE FOR MACHINE

(71) Applicant: Caterpillar Inc., Peoria, IL (US)

(72) Inventors: Britta A. Jost, Mackinaw, IL (US); Jianping Z. Li, Peoria, IL (US); Travis A. Ducheneaux, Dunlap, IL (US); Kevin P. Zimmerman, Washington, IL (US); Steve A. Rager, Tremont, IL (US)

(73) Assignee: Caterpillar Inc., Peoria, IL (US)

(21) Appl. No.: 15/137,325

(22) Filed: Apr. 25, 2016

(51) Int. Cl. F16H 57/025

(52) U.S. Cl. CPC F16H 57/025

(57) ABSTRACT

A transmission case for a machine having a power source and a drive train assembly adapted to receive power from the power source is provided. The transmission case includes an encasing member, a plurality of side rails and a unitary rear wall which are coupled to one another to define an enclosure therebetween. The unitary rear wall includes a rear plate. The rear plate includes plurality of threaded holes provided at the peripheral end portions of the rear plate. The rear plate also includes a through hole. The unitary rear wall also includes a machined portion defined along the through hole. The unitary rear wall further includes a lubricant drain provision. The lubricant drain provision is provided at the bottom portion of the rear plate. The unitary rear wall includes a plurality of mounts, which are provided on a top portion of the rear plate.

### TECHNICAL FIELD

The present disclosure relates to track-type machines and more particularly to a transmission case for a track-type machine.

### BACKGROUND

In general, machines such as track-type tractors are employed for various construction or earthmoving tasks. Typically, a track-type tractor includes a transmission case and a main frame for supporting an engine and a transmission system drivably connected to the engine. The transmission case is defined by a set of plates including a rear plate. The rear plate acts as a seal, preventing lubricant leakage from the transmission case. Typically, the rear plate includes various components welded together. For example, a set of rear attachment mounting members are welded to the rear plate. Likewise, a transmission mounting ring is welded on the rear plate and then machined. Further, a plurality of machining operations such as drilling, boring, etc. are carried out on the rear plate after the rear plate is connected to the transmission case. Since the rear plate includes a number of components welded together, problems, such as leakage of lubricant from the transmission case often arise. Further, performing various manufacturing operations on the rear plate can be difficult and expensive, since these operations are required to be carried out after the installation of the rear plate on the rest of the transmission case.

### SUMMARY OF THE DISCLOSURE

According to one aspect of the present disclosure, a transmission case for a machine is provided. The machine includes a power source and a drive train assembly adapted to receive power from the power source. The transmission case includes an encasing member. The transmission case also includes a pair of side rails. The side rails are coupled to the opposite ends of the encasing member. The pair of side rails extends along a longitudinal axis to form a frame assembly of the machine supporting the power source. The transmission case further includes a unitary rear wall. The unitary rear wall is coupled to the encasing member and the pair of side rails to define an enclosure. The enclosure is adapted to hold the drive train assembly. The unitary rear wall includes a rear plate. The rear plate includes plurality of threaded holes. The rear plate also includes a through hole. The plurality of threaded holes is provided at the peripheral end portions of the rear plate. The plurality of threaded holes enables connection of one or more rear attachments to the rear plate. The unitary rear wall also includes a machined portion. The machined portion is defined along the through hole. The machined portion supports the drive train assembly received within the enclosure. The unitary rear wall further includes a lubricant drain provision. The lubricant drain provision is provided at the bottom portion of the rear plate. The lubricant drain provision selectively allows drainage of lubricant contained in the enclosure. The unitary rear wall includes a plurality of mounts, which are provided on a top portion of the rear plate. The plurality of mounts facilitates in connection of a roll over protective structure to the rear plate.

Other features and aspects of this disclosure will be apparent from the following description and the accompanying drawings.

### BRIEF DESCRIPTION OF THE DRAWINGS

FIG. 1 is a side view of a machine, according to an aspect of the present disclosure.

FIG. 2 is an exploded view of a frame assembly of machine of FIG. 1 with various attachments connected to the frame assembly.

FIG. 3 is a perspective view of a frame assembly of the machine of FIG. 1.

FIG. 4 is a perspective view of a transmission case of FIG. 2; and

FIG. 5 is a perspective view of a unitary rear plate of the transmission case of FIG. 2.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. Any reference to elements in the singular is also to be construed to relate to the plural and vice-versa without limiting the scope of the disclosure to the exact number or type of such elements unless set forth explicitly.

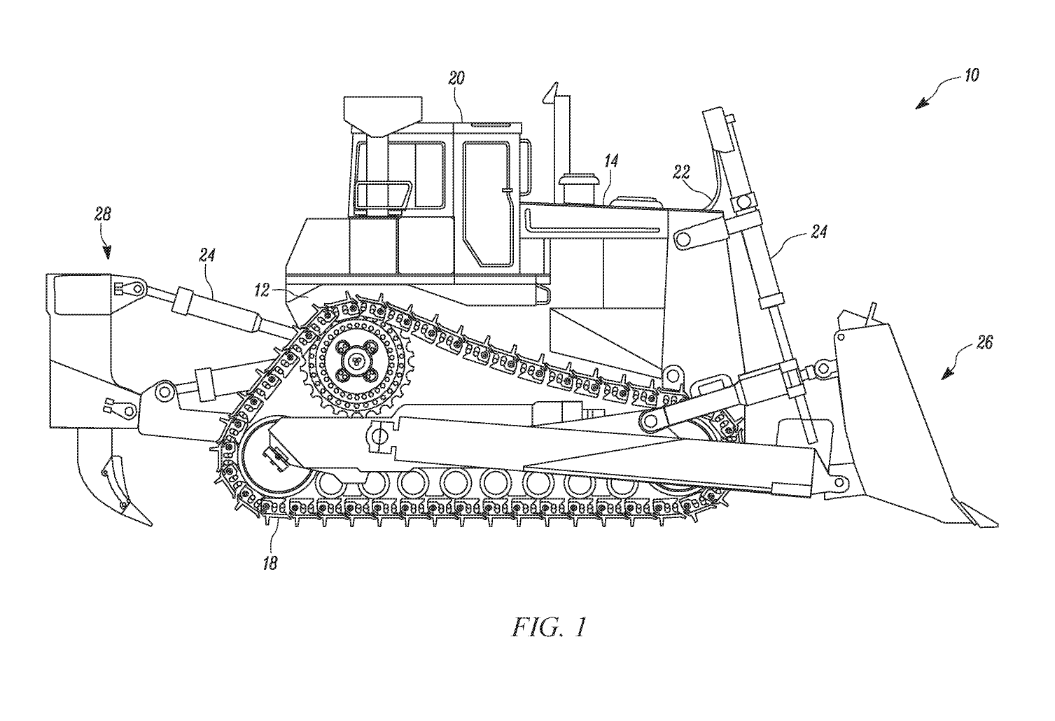

FIG. 1 illustrates a side view of an exemplary machine 10, according to one embodiment of the present disclosure. As illustrated, the machine 10 is embodied as a track type machine such as a track type tractor. Alternatively, the machine 10 may be a backhoe loader, a skid steer loader, a wheel loader, a motor grader, an excavator, a scraper, an agricultural tractor, a wheel loader, a haul truck, and the like. It should be understood that the machine 10 may embody any wheeled or tracked machine associated with mining, agriculture, forestry, construction, and other industrial applications.

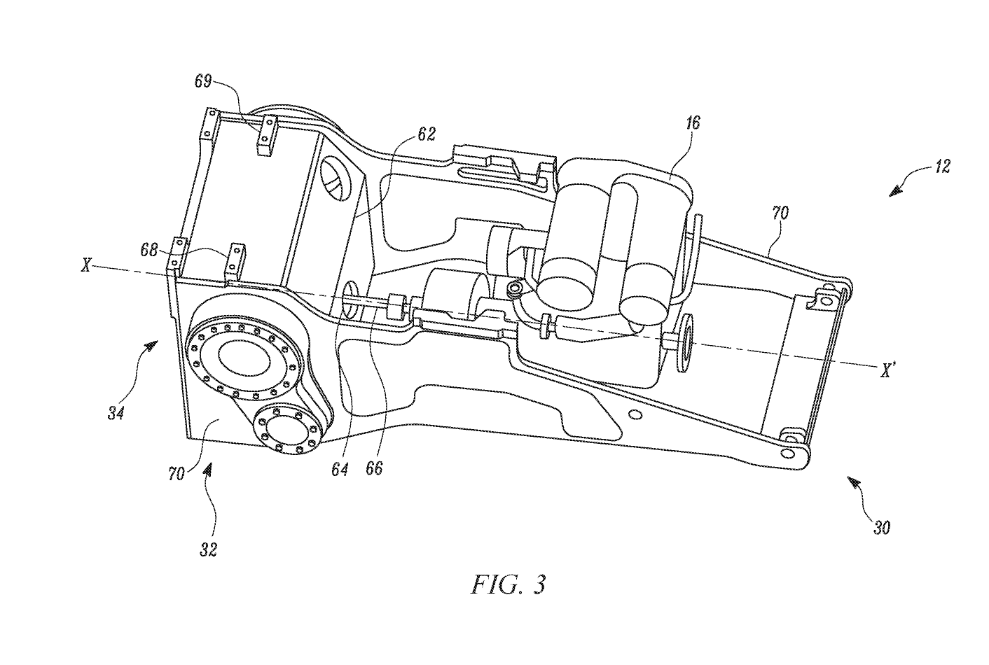

Referring to FIG. 1, the machine 10 includes a frame assembly 12 and an engine enclosure 14. The engine enclosure 14 houses a power source 16 (shown in FIG. 3) to provide power to the machine 10. The power source 16 may include one or more engines, power plants or other power delivery systems like batteries, hybrid engines, electric motors, or any other power sources known in the art. A set of ground engaging members 18 such as wheels, tracks, rollers and the like, are also provided on the machine 10 for propelling the machine 10. Further, the machine 10 includes an operator cabin 20 which includes a plurality of input devices (not shown) for controlling and monitoring operations of the machine 10. The input devices may include, but are not limited to, a push-button, a control lever, and a steering wheel.

The machine 10 includes a hydraulic pump (not shown). The hydraulic pump may be operatively coupled to the power source 16 to provide pressurized hydraulic fluid via a number of hoses 22 to a number of hydraulic cylinders 24 for lifting or otherwise moving the tools and implements.

The machine 10 includes a front attachment 26. In the illustrated example, the front attachment 26 is embodied as a blade assembly. The machine 10 further includes a rear attachment 28. The rear attachment 28 may include a ripper assembly, a winch assembly, a drawbar assembly or any other rear attachments known in the art. In the illustrated example, the rear attachment 28 is embodied as a ripper assembly. In an example, the rear attachment 28 may include, but is not limited to fixed parallelogram linkage configuration, variable parallelogram linkage configuration, fixed or variable shapes that are other than a parallelogram linkage configuration or any other ripper linkage configurations known in the art.

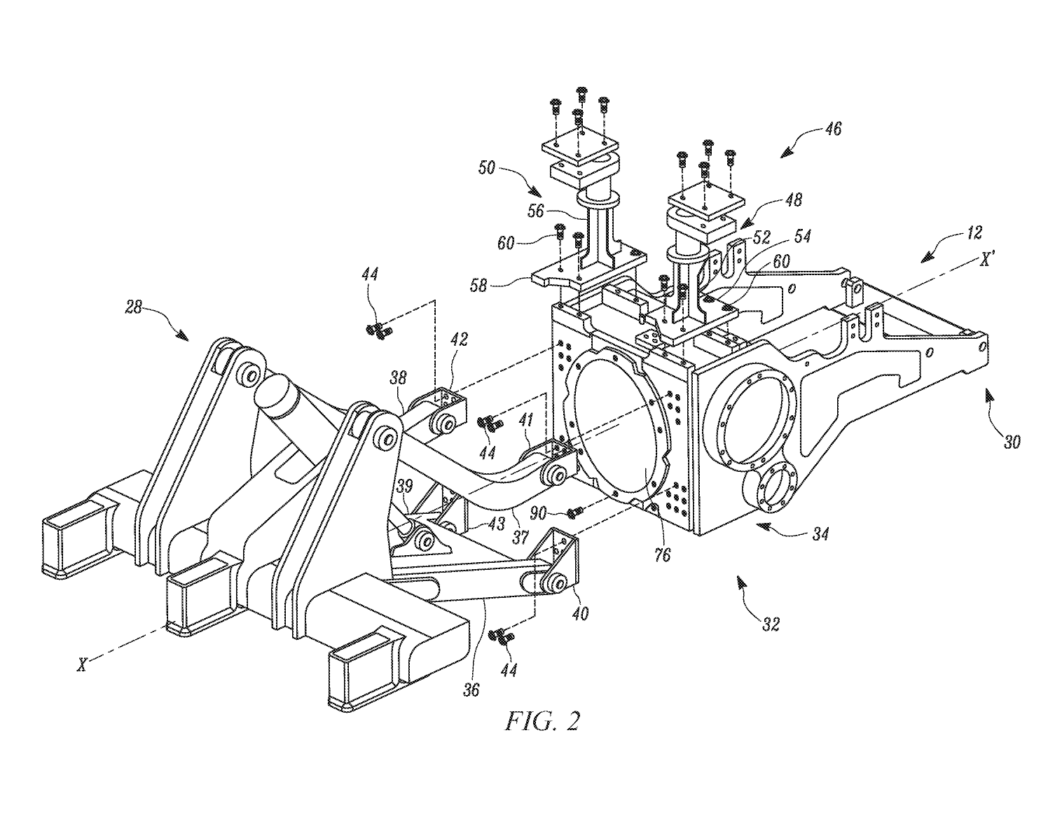

As shown in FIG. 2, the frame assembly 12 of the machine 10 includes a front portion 30 and a rear portion 32 opposite to the front portion 30 along a longitudinal axis X-X′. The power source 16 is mounted on the front portion 30 of the frame assembly 12 (shown in FIG. 3). The rear portion 32 of the frame assembly 12 includes a transmission case 34. The transmission case 34 of the frame assembly 12 supports the rear attachment 28.

The rear attachment 28 includes a set of link members, such as a first link member 36, a second link member 37, a third link member 38 and a fourth link member 39. Each of the set of link members includes a tractor mount. For example, the first link member 36 includes a first tractor mount 40, the second link member 37 includes a second Exactor mount 41, the third link member 38 includes a third tractor mount 42 and the fourth link member 39 includes a fourth tractor mount 43. The first, the second, the third and the fourth tractor mounts 40, 41, 42, 43 of the rear attachment 28 are coupled to the transmission case 34 via a number of fastening members such as first fastening members 44. Although, the figure illustrates four link members 36, 37, 38, 39 coupled to the transmission case 34, the number of link members may vary based on system requirements.

The transmission case 34 also supports a Roll Over Protective Structure 46 (hereinafter referred to as “ROPS 46”) of the operator cabin 20. The ROPS 46 includes a first connecting structure 48 and a second connecting structure 50. The first connecting structure 48 includes a first bar member 52. The first connecting structure 48 further includes a first flange 54. The first flange 54 is secured to the bottom end of the first bar member 52. The second connecting structure 50 includes a second bar member 56. The second connecting structure 50 further includes a second flange 58. The first flange 54 and the second flange 58 of the ROPS 46 are coupled to the transmission case 34 of the frame assembly 12 via a number of second fastening members 60. The first and the second fastening members 44, 60 may include, but are not limited to screws, bolts, rivets or any other fastening elements known in the art.

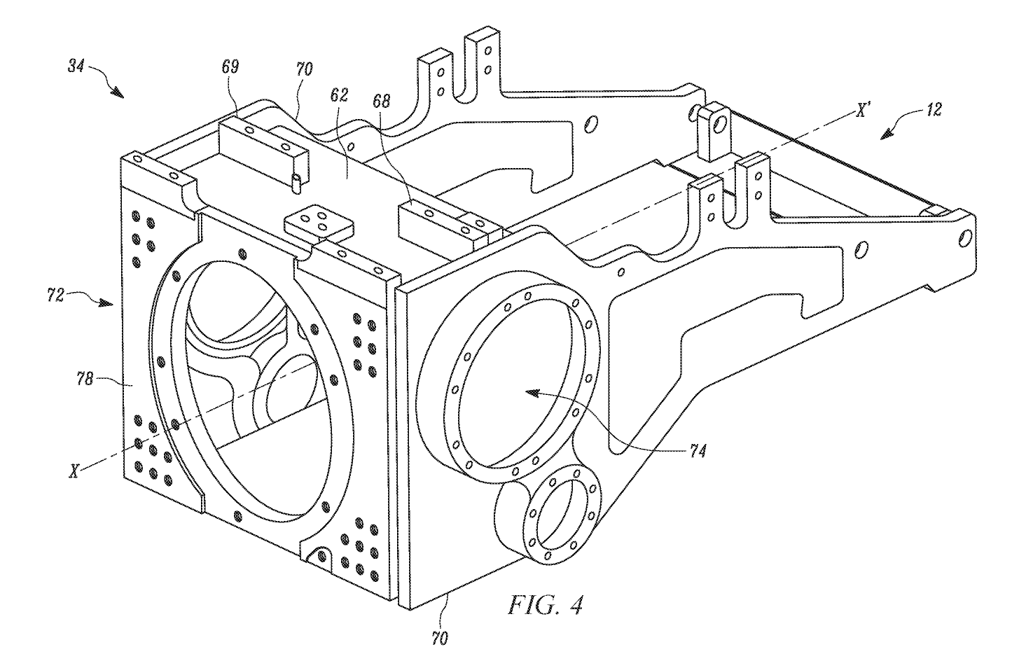

Referring to FIGS. 3 and 4, the transmission case 34 of the frame assembly 12 includes an encasing member 62. The encasing member 62 includes an opening 64 for receiving an output shaft 66 from the power source 16. In alternative examples, where the power source 16 is an electric motor instead of a traditional transmission, the encasing member 62 will not have the opening 64 for receiving the output shaft 66. The encasing member 62 may be manufactured from a variety of materials including, but not limited to carbon steel, alloy steel, aluminum alloys or any other materials known in the art.

The transmission case 34 includes a first mount 68 and a second mount 69. The first mount 68 and the second mount 69 are secured to the encasing member 62 by welding. The transmission case 34 includes a pair of side rails 70. The side rails 70 are coupled to the opposite ends of the encasing member 62 by welding, fastening, riveting, or by other fixed or removable connecting means known in the art. The side rails 70 extend along the longitudinal axis X-X′ to form the frame assembly 12 of the machine 10. The side rails 70 may be manufactured from materials including, but not limited to steel plate, cast materials, composite materials or any other materials known in the art.

The transmission case 34 further includes a unitary rear wall 72. The unitary rear wall 72 is coupled to the encasing member 62 and the side rails 70 to define an enclosure 74. The enclosure 74 houses a drive train assembly (not shown) of the machine 10. Further, the enclosure 74 also houses the transmission lubricant provided for the operation of the drive train assembly. The drive train assembly receives power from the power source 16. The drive train assembly may include a mechanical drive, a hydraulic drive, or a combination thereof. The transmission case 34 includes an annular shaped plate 76 (as shown in FIG. 2).

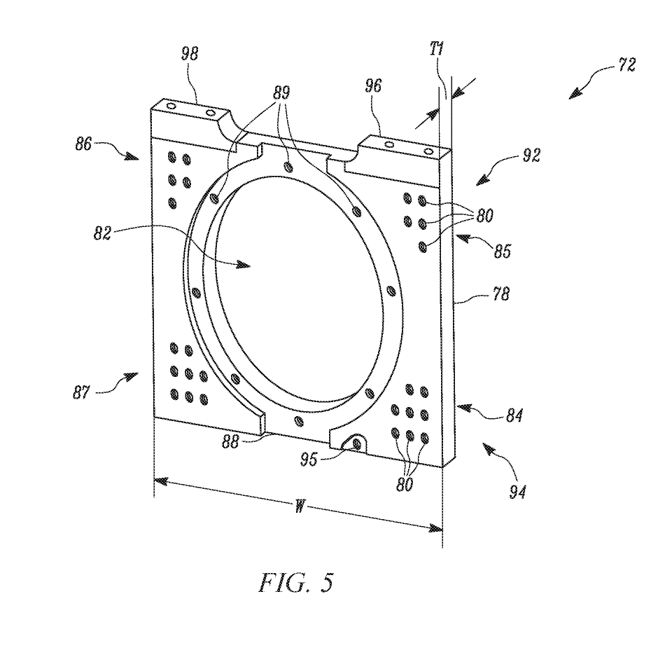

Referring to FIG. 5, the unitary rear wall 72 includes a rear plate 78 with a thickness ‘T1’ and a width ‘W’. The rear plate 78 may be made from variety of materials including, but not limited to alloy steel, cast iron or any other materials known in the art. The rear plate 78 may be manufactured using variety of manufacturing process including, but not limited to casting, molding, or any other manufacturing processes known in the art.

The rear plate 78 includes a number of threaded holes 80 and a through hole 82, Although the rear plate 78 disclosed herein includes the threaded holes 80, it may be contemplated that the rear plate 78 may include different types of holes known in the art. The rear plate 78 includes a first peripheral end portion 84, a second peripheral end portion 85, a third peripheral end portion 86 and a fourth peripheral end portion 87. The threaded holes 80 are provided at the first, the second, the third and the fourth peripheral end portions 84, 85, 86, 87 of the rear plate 78. The threaded holes 80 receive the first fastening members 44 thereby, respectively securing the first, the second, the third and the fourth tractor mounts 40, 41, 42, 43 of the rear attachment 28 to the rear plate 78 of the transmission case 34 (shown in FIG. 2). Further, the rear plate 78 may also include additional threaded holes (not shown) around the through hole 82. The additional threaded holes may be used to mount the transmission or the electric motor.

The unitary rear wall 72 further includes a machined portion 88. The machined portion 88 is defined along the through hole 82. In an illustrated example, the machined portion 88 may have a circular profile. Alternatively, the machined portion 88 may have elliptical profile, oval profile or any other similar profile known in the art. The machined portion 88 includes a number of threaded holes 89. The threaded holes 89 receive a number of third fastening members 90. The third fastening members 90 couples the annular shaped plate 76 to the machined portion 88(shown in FIG. 2). The annular shaped plate 76 is configured to support the drive train assembly within the enclosure 74. The third fastening members 90 may include, but are not limited to screws, bolts or any other fastening elements known in the art.

Referring to FIG. 5, the unitary rear wall 72 includes a top portion 92 and a bottom portion 94 opposite to the top portion 92. The unitary rear wall 72 includes a lubricant drain opening 95. The lubricant drain opening 95 is located at the bottom portion 94 of the rear plate 78. The lubricant drain opening 95 is configured to selectively allow drainage of lubricant from the enclosure 74 (FIG. 4). The unitary rear wall 72 includes a third mount 96 and a fourth mount 98. The third and the fourth mounts 96, 98 are located on the top portion 92 of the unitary rear wall 72. The first, the second, the third and the fourth mounts 68, 69, 96, 98 receive the second fastening members 60, securing the first connecting structure 48 and the second connecting structure 50 of the roll over protective structure 46. The thickness ‘T1’ of the rear plate 78 may be selected such that the rear plate 78 withstands the combined forces exerted on the frame assembly 12 by different components mounted on the frame assembly 12. The width ‘W’ of the rear plate 78 may be selected such that it defines a width of the rear portion 32 of the frame assembly 12.

### INDUSTRIAL APPLICABILITY

The present disclosure relates to the unitary rear wall 72 for the transmission case 34 of the machine 10. The unitary rear wall 72 reduces number of components being used thereby easing the machine 10 assembly and/or avoid or limit the introduction of structural weakness into the frame assembly 12 of the machine 10. The unitary rear wall 72 improves the overall durability and simplifies the overall structure of the transmission case 34. The third and fourth mounts 96, 98 present on top of the rear plate 78 facilitates mounting of the ROPS 46. The threaded holes 80 present on the first, the second, the third and the fourth peripheral end portion 84, 85, 86, 87 of the rear plate 78 receives the first fastening members 44 through the first, the second, the third and the fourth tractor mounts 40, 41., 42, 43 facilitating in the mounting of the rear attachment 28.

The width ‘W’ of the rear plate 78 of the unitary rear wall 72 leads to improved manufacturability of the frame assembly 12. Since the threaded holes 80 are readily provided on the rear plate 78 machining of the rear plate 78 whilst the rear wall is attached to the transmission case 34 may be avoided. It is contemplated that the unitary rear wall 72 efficiently prevents lubricant oil leakage from the transmission case 34. The lubricant drain opening 95 provided at the bottom portion 94 of the rear plate 78 of the unitary rear wall 72, facilitates smooth draining of the lubricant present in the enclosure 74 of the transmission case 34.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A transmission case for a machine having a power source and a drive train assembly adapted to receive power from the power source, the transmission case comprising:
an encasing member;
a pair of side rails coupled to opposite ends of the encasing member and extending along a longitudinal axis to form a frame assembly of the machine supporting the power source; and
a unitary rear wall coupled to the encasing member and the pair of side rails to define an enclosure adapted to hold the drive train assembly, the unitary rear wall comprising:
a rear plate having a plurality of threaded holes and a through hole, Wherein the plurality of threaded holes are provided at peripheral end portions of the rear plate to enable connection of one or more rear attachments to the rear plate;
a machined portion defined along the through hole for supporting the drive train assembly received within the enclosure;
a lubricant drain provision provided at a bottom portion of the rear plate for selectively allowing drainage of lubricant contained in the enclosure; and
a plurality of mounts provided on a top portion of the rear plate, the plurality of mounts facilitate connection of a roll over protective structure to the rear plate.
